(19) United States
(12) Patent Application Publication
(10) Pub. No.: US 2013/0036601 A1
(43) Pub. Date: Feb. 14, 2013

(54) Wind Turbine with Prestressable Supporting Arms

(71) Applicant: Olivier Blanc, Rosemere (CA)

(72) Inventor: Olivier Blanc, Rosemere (CA)

(21) Appl. No.: 13/576,018

(22) PCT Filed: Jan. 27, 2011
(86) PCT No.: PCT/CA2011/000100

§ 371 Date: Oct. 15, 2012

Related U.S. Application Data
(60) Provisional application No. 61/282,362, filed on Jan. 28, 2010.

(30) Foreign Application Priority Data
Jan. 28, 2010 (CA) 2690955

(51) Int. Cl. F03D 3/06; B23P 11/00; F03D 11/04

(52) U.S. Cl. 29/596; 416/211; 416/174; 416/194; 29/889

(57) ABSTRACT

There is provided a vertical axis wind turbine comprising an upright rotatable shaft mountable on a support structure, a plurality of upright blades, and a plurality of prestressable supporting arms for attaching the plurality of blades to the shaft. The wind turbine may further comprise a shaft stabilizing assembly comprising a plurality of coplanar wheels having compliant outer layers, rotatably mounted on a support, for radially and rotatably supporting a rotatable shaft. The disclosure further provides a method of assembly of the wind turbine.

### TECHNICAL FIELD

The present disclosure generally relates to vertical axis wind turbine. More specifically, the present disclosure relates to a vertical axis wind turbine having prestressable supporting arms, to a method of assembly therefor and to a shaft stabilizing assembly useable for stabilizing a wind turbine.

### BACKGROUND

Some vertical axis wind turbine structures are known as of Darrieus wind turbines. Turbines according to this concept consist of a number of generally vertical, curved aerofoil blades mounted on a vertical rotating shaft. The Darrieus approach is to curve the blades into a so called “egg-beater” shape, in which the blades are attached to the shaft at each extremity. Blades of a Darrieus wind turbine are self supported, do not require heavy supports and mountings and maintain the center of mass of the mechanism relatively close to the shaft and to the axis of the central tower. Although this type of structure has some advantages over propeller type wind turbines, some drawbacks tend to limit their usage. The “egg-beater” shape reduces the torque resulting by the lift force vector of the blades on the shaft, in turn reducing overall efficiency of the turbine. Another problem encountered with the Darrieus turbine lies in high centrifugal forces on the structure, since a significant part the mass of its rotating mechanism is at its periphery rather than proximal to the shaft.

Another type of vertical axis wind turbine is known as the Giromill wind turbine. This turbine uses generally straight vertical blades attached to a vertical rotating shaft via supporting arms. The Giromill turbine may be more efficient than the Darrieus turbine in converting wind force into output torque, but a majority of its mass is distributed away from the rotating shaft. Consequently, the Giromill wind turbine suffers from even higher centrifugal forces.

Several attempts have been made to improve the strength of vertical axis turbines, using heavier parts and a plurality of struts and/or tie wires that increase weight and aerodynamic drag, leading to lower efficiency and higher costs. For example, publication number WO 2008/131519 to Lux, published on Nov. 6, 2008, discloses a structure wherein exposed cables encircle the turbine to keep blades in a prestressed condition, the “egg-beater” shape of the blades being conferred by the encircling cables.

Another problem arising in vertical axis wind turbines lies in a sinusoidal pulsing torque caused by a changing angle of attack as the turbine spins. This causes vibrations and risks of resonance and breakage, at variable speeds. Additionally, vertical wind turbines are typically permanently mounted using welded or riveted assemblies and sealed ball or roller bearings for their rotating shaft. Consequently, repairs are complex and expensive. Finally, broken portions of the rotating parts such as blades and arms may become loose and become hazardous for surrounding structures and people.

### SUMMARY

There is therefore a need to provide a vertical wind turbine structure, a related method of assembly, and a shaft stabilizing assembly, that obviate the limitations and drawbacks of the earlier wind rotors and methods.

More specifically, in accordance with the present disclosure, there is first provided a vertical axis wind turbine comprising an upright rotatable shaft mountable on a support structure, a plurality of upright blades, and a plurality of prestressable supporting arms for attaching the plurality of blades to the shaft.

According to another aspect of the disclosure, there is provided a method for assembling a wind turbine. The method comprises mounting a rotatable shaft on a support structure, attaching a plurality of supporting arms to the shaft, attaching a plurality of blades to the shaft using the plurality of supporting arms, and prestressing the plurality of supporting arms.

According to a further aspect of the disclosure, there is provided a shaft stabilizing assembly comprising a plurality of coplanar wheels having compliant outer layers, rotatably mounted on a support, for radially and rotatably supporting a rotatable shaft.

According to yet another aspect of the disclosure, a shaft stabilizing assembly comprising a plurality of coplanar wheels having compliant outer layers, rotatably mounted on a support, for radially and rotatably supporting a rotatable shaft, is provided for use in stabilizing a wind turbine.

According to a still further aspect of the present disclosure, there is provided a vertical axis wind turbine comprising an upright rotatable shaft mountable on a support structure, a plurality of upright blades, and a plurality of prestressed supporting arms for attaching the plurality of blades to the shaft.

The foregoing and other objects, advantages and features of the present disclosure will become more apparent upon reading of the following non-restrictive description of an illustrative embodiment thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a general perspective view of an example of wind turbine structure according to an embodiment;

FIG. 2 is an enlarged perspective view of a upper portion of the wind turbine structure of FIG. 1;

FIG. 3 is a perspective view showing details of a upper connecting hub of the wind turbine structure of FIGS. 1 and 2;

FIG. 4 is a perspective view of the upper connecting hub of FIG. 3, with tensioning rods secured to the hub;

FIG. 5a is a perspective view of the upper connecting hub of FIG. 4, with supporting arms affixed to the hub;

FIG. 5b is a detailed perspective view of a distal end of a supporting arm mounted on tensioning rods;

FIG. 6 is a detailed perspective view showing a blade mounted at a distal end of a supporting arm with tensioning rods protruding therethrough;

FIGS. 7a and 7b are detailed perspective views of the blade, supporting arm and tensioning rods of FIG. 6, showing a blade conforming securing sleeve (FIG. 7a) and an end cap (FIG. 7b);

FIGS. 8a and 8b are perspective views showing details of a shaft stabilizing assembly of the wind turbine structure of FIG. 1;

FIG. 9 shows steps of a first exemplary method for assembling a wind turbine; and

FIG. 10 shows steps of a second exemplary method for assembly a wind turbine.

### DETAILED DESCRIPTION

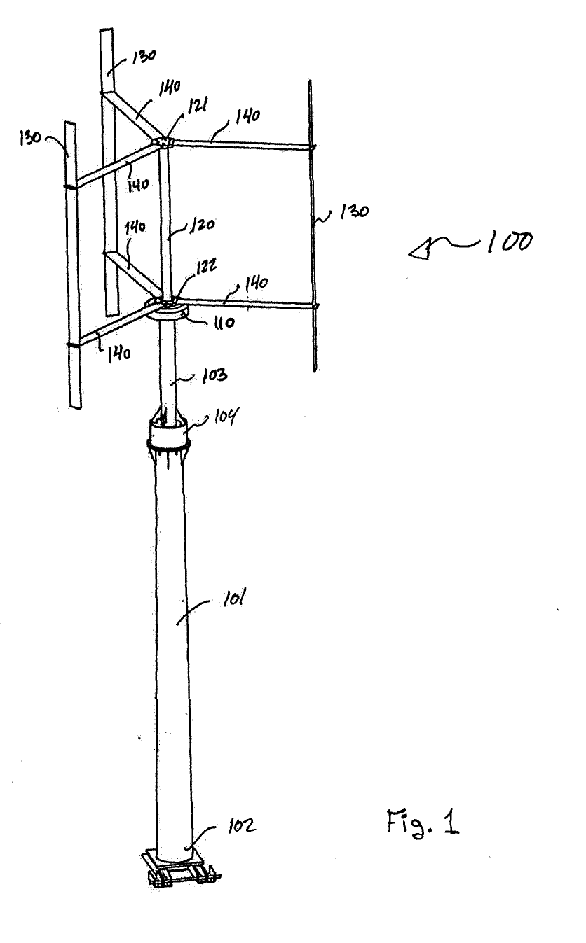

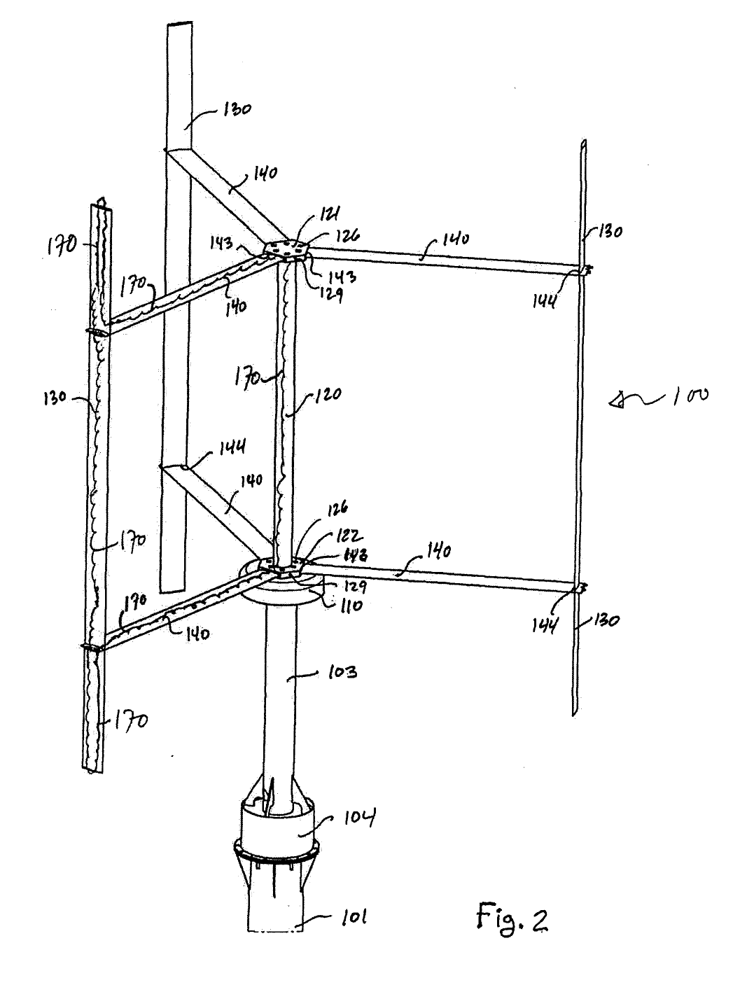

FIG. 1 is a general perspective view of an example of wind turbine structure according to an embodiment. FIG. 2 is an enlarged perspective view of a top portion of the wind turbine structure of FIG. 1. Referring at once to FIGS. 1 and 2, a non-restrictive illustrative embodiment of the present disclosure relates to a wind turbine 100 mounted on a generally vertical central tower 101 having a base section 102 and a top section 103, the tower 101 also having an intermediate generator section 104. In the context of the present disclosure, the term “tower” is used to refer to a variety of support structures including a pole, a post, a mast or any similar upright structure capable of supporting a wind turbine. A length of the support structure may vary depending on the needs of an application. As a non-limiting example, a wind turbine installed atop a mountain may only require a short mast in order to provide adequate wind exposure. The upright structure may be affixed to the ground or atop another structure, such as a building, using any suitable type of base and the shown base section 102 is only for purposes of illustration. As shown on FIG. 1, the generator section 104 is at an intermediate position along the length of the tower. Of course, the generator section 104 may be placed at various locations along the wind turbine 100, without departing from the scope of the present disclosure. The top section 103 is terminated by a shaft stabilizing assembly 110, described in greater detail hereinbelow.

The wind turbine 100 further comprises a generally vertical shaft 120 co-extending from the top section 103 of the tower 101 and rotatably coupled thereto and to the generator section 104 in a manner that will be described hereinafter. The shaft 120 is provided with an upper connecting hub 121 and a lower connecting hub 122 strongly secured thereto, capable of transmitting a heavy torque to the generator section 104. The hubs 121 and 122 are adapted for removably securing a plurality of upper and lower elongated, prestressable supporting arms 140 and a plurality of corresponding, generally vertical blades 130 to the shaft 120. In the context of the present disclosure, the term “prestress” and its variants refer to application of a stress within an element of the wind turbine 100 while it is in stationary position, this stress opposing centrifugal forces that will be exerted on the wind turbine 100 when it is rotating, in operation. As shown on FIG. 1, three pairs of substantially parallel supporting arms 140 extend radially from the shaft and support three (3) blades 130. In an embodiment, one or more supporting arms may support each of a variable number of blades and, for example, two non-parallel supporting arms may connect to the shaft 120 at a single centrally located hub. In yet another embodiment, the blades may be curved, whereby the wind turbine may adopt at least in part the “egg-beater” shape of Darrieus wind turbines. Other variations will come to mind to those of ordinary skill in the art having the benefit of the present disclosure. The wind turbine 100 having three (3) straight vertically blades 130 connected to the shaft 120 using two parallel supporting arms 140 is presented solely for non-limiting illustration purposes.

The blades 130 may be provided with an aerofoil shape, or wing shape, so to generate a lift force thereon when being stricken by the wind, in turn generating a torque causing rotation of the shaft 120. Blades 130 that are straight along their vertical length may be provided for increased efficiency for a given turbine diameter. In addition, in order to minimize aerodynamic drag, the supporting arms 140 may also be provided with an aerofoil shape, for example adopting the same shape as that of the blades 130. In an embodiment, blades 130 and supporting arms 140 may be fabricated from similar elongated members, which may be obtained by extrusion of metallic material such as aluminum. Extrusion of a thermoplastic material or pultrusion or molding of composite material may also be contemplated. Supporting arms 140, and similarly blades 130, may have a hollow cross section defining a plurality of elongated cylindrical through cavities, illustrated hereinbelow. Safety cables 170 may extend through such cavities of the supporting arms 140 and blades 130 and may further extend through the shaft 120. The following figures and their description will provide details on how prestress may be applied to the supporting arms 140, and provide details on the safety cables 170.

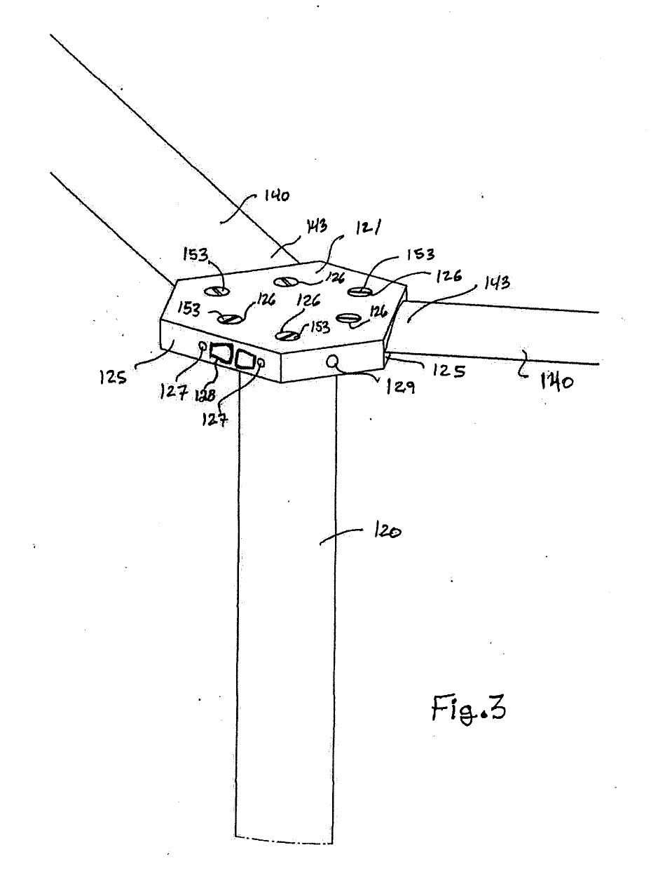

FIG. 3 is a perspective view showing details of an upper connecting hub of the wind turbine structure of FIGS. 1 and 2. In FIG. 3, the upper connecting hub 121 defines a generally hexagonal plate having three (3) similar arm connecting faces such as 125. Of course, for a wind turbine having another number of blades, a shape of the hub and a number of arm connecting faces 125 may differ. A pair of holes 126 is provided across the plate in front of each face 125. A second pair of holes 127 is drilled from the face 125 to open up in the holes 126. The hub 121 further comprises a pair of ridges 128 projecting from the face 125 and having a shape and size adapted to conform to and snugly fit into the through cavities of the supporting arms 140. The shape and number of ridges 128 is exemplary and may be modified by those of ordinary skills in the art. It is to be noted that the lower hub 122 has a similar structure to that of hub 121 for securing the supporting arms 140 thereto, except that its plate has an annular shape to be traversed by the shaft 120. Securing threaded holes such as 129 are further provided to secure the hub 122 to the shaft 120 using set screws (not shown).

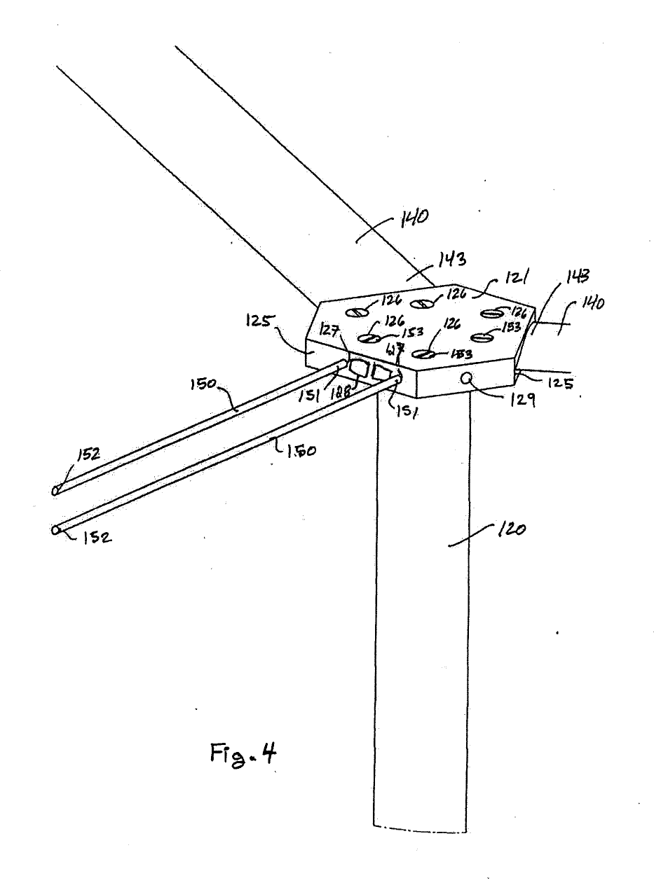

FIG. 4 is a perspective view of the upper connecting hub of FIG. 3, with tensioning rods secured to the hub. The wind turbine 100 comprises a plurality of elongated tensioning members such as rods 150, each rod 150 having a first threaded end 151 adapted to be snugly inserted into a hole 127 and extend into a hole 126 to be screwed into a threaded hole (not shown) provided in a side wall of a generally cylindrical barrel 153 axially sled into each hole 126. Thereby, a rod 150 may be accurately assembled without having to provide lateral blind threaded holes in the hubs 121 and 122 for receiving the rod ends 151.

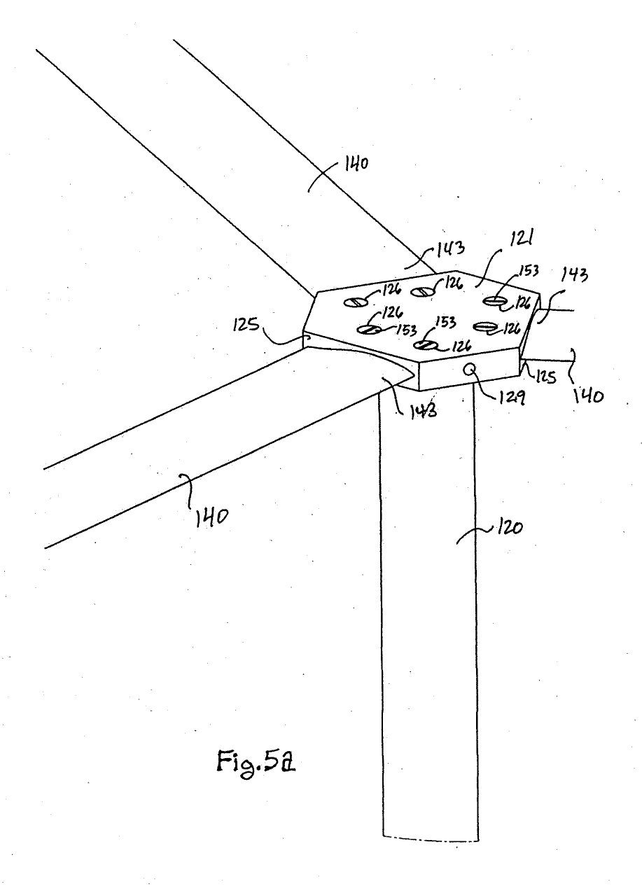

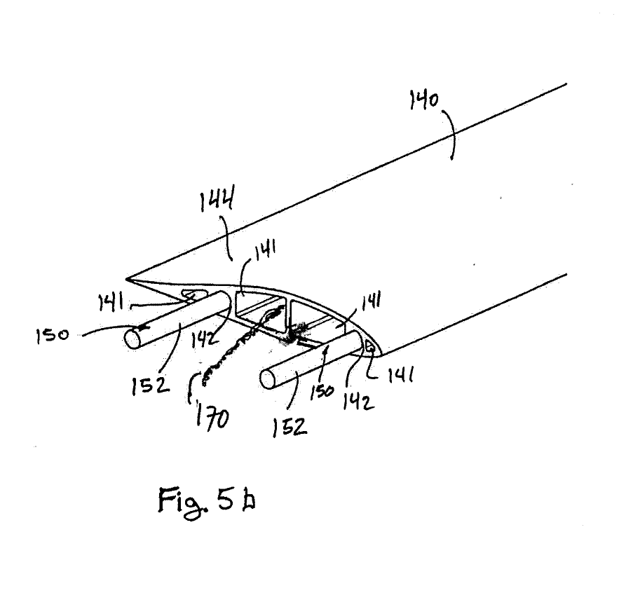

FIG. 5a is a perspective view of the upper connecting hub of FIG. 4, with supporting arms affixed to the hub. FIG. 5b is a detailed perspective view of a distal end of a supporting arm mounted on tensioning rods. As shown in FIGS. 5a and 5b, the supporting arms 140 may be mounted on the rods 150 by inserting the rods 150 through circular axial cavities 142 of the supporting arms 140. When a proximal end 143 of the supporting arm 140 abuts on the face 125 of the hub 121, ridges 128 (shown on FIG. 3) projecting from the surface 125 may penetrate into at least some of channels 141 to lock the supporting arm 140, preventing rotation about its longitudinal axis. In the example of the wind turbine 100, a total of six (6) supporting arms 140 are similarly mounted on the upper hub 121 and the lower hub 122 using twelve (12) rods for supporting three (3) blades 130.

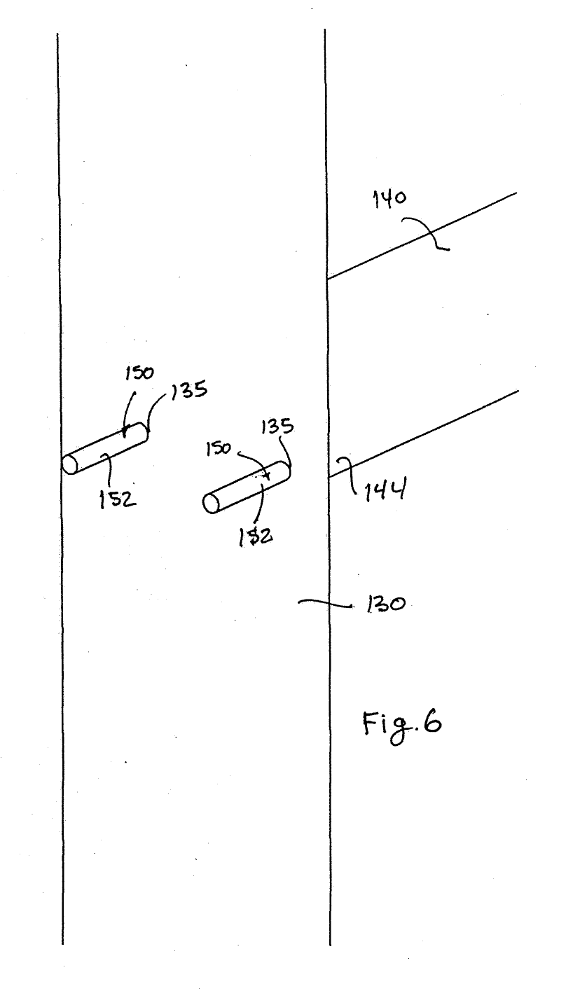

FIG. 6 is a detailed perspective view showing a blade mounted at a distal end of a supporting arm with tensioning rods protruding therethrough. FIG. 6 shows that blades 130 are provided with upper and lower pairs of through holes 135 (only one such pair is shown) adapted to snugly receive second ends 152 of the rods 150. Distal ends 144 of the supporting arms 140 may be shaped to conform to the aerofoil profile of corresponding blades 130 so that each blade 130 may be inserted on the ends 152 of the upper and lower pairs of rod 150 and stably rest against the distal ends 144. Alternatively, the ends 144 may be cut straight and molded shape adapting spacers (not shown) may be inserted on the rod ends 152 between the ends 144 and the blades 130.

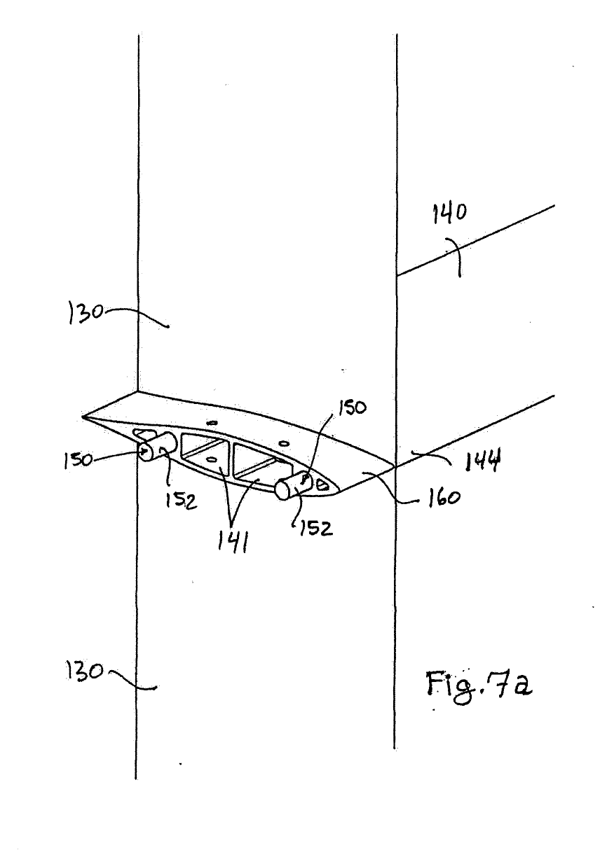

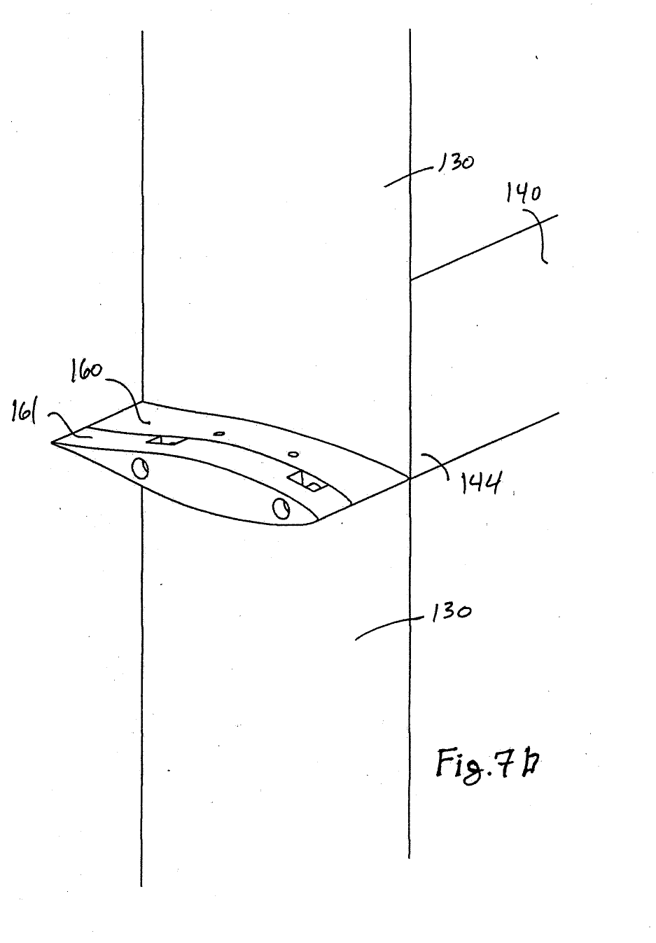

FIGS. 7a and 7b are detailed perspective views of the blade, supporting arm and tensioning rods of FIG. 6, showing a blade conforming securing sleeve (FIG. 7a) and an end cap (FIG. 7b). The blades 130 are secured in place as seen from FIG. 7a, using a shape conforming end sleeve 160 and removable fasteners such as nuts (not shown) fastened on threaded portions of rod ends 152. An end cap 161 may be further mounted on the sleeve 160 to provide a clean finish as shown in FIG. 7b. Fastening of the nuts is performed to yield a desired tension in the tensioning rods 150. Tensioning of the rods 150 exerts a compression stress on the blades 130, the supporting arms 140 and the sleeves 160, between the hubs 121, 122 and the rod ends 152 terminated by removable fasteners. The provided prestress of the supporting arms 140 opposes centrifugal forces and vibrations of the wind turbine 100, as it rotates, maintaining rigidity of the wind turbine 100 without the help of external struts or tie wires, avoiding the addition of weight and aerodynamic drag to the wind turbine 100. In an embodiment, an amount of prestress applied to the supporting arms 140 may be determined according to a centrifugal force on the wind turbine 100 at an expected maximum rotation speed or at an expected maximum wind force.

In an alternate embodiment, the rods 150 may be replaced by tensioning wires (not shown). The tensioning wires may be attached at the hubs 121, 122 and at the sleeves 160, using appropriate fastening means, in a manner that exerts tension on the wires so that the sleeves 160 transfer pressure on the blades 130 and on the supporting arms 140, adding a compression stress, or prestress, on the supporting arms 140.

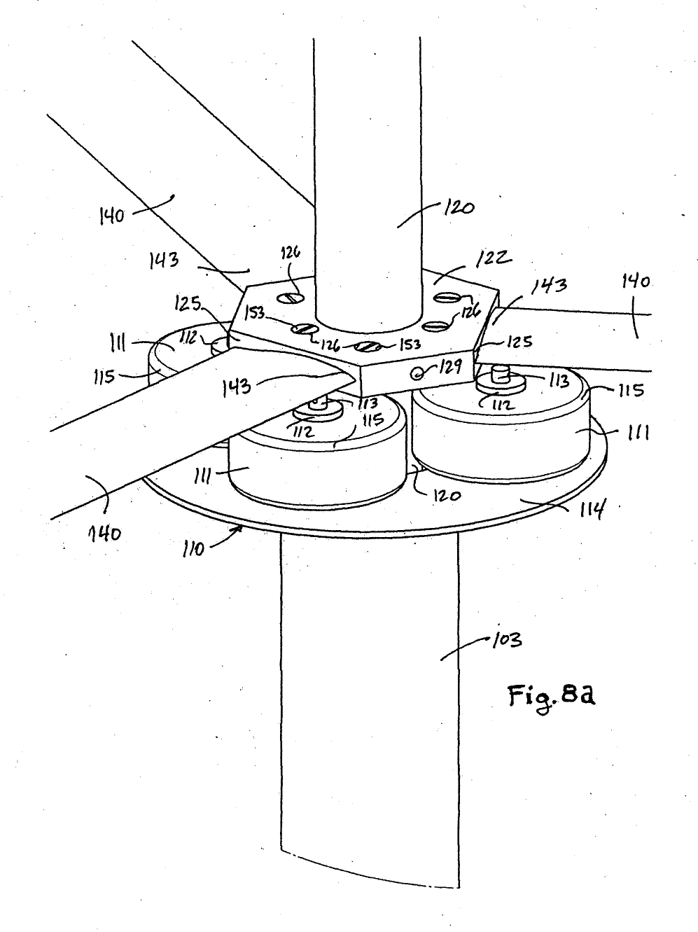

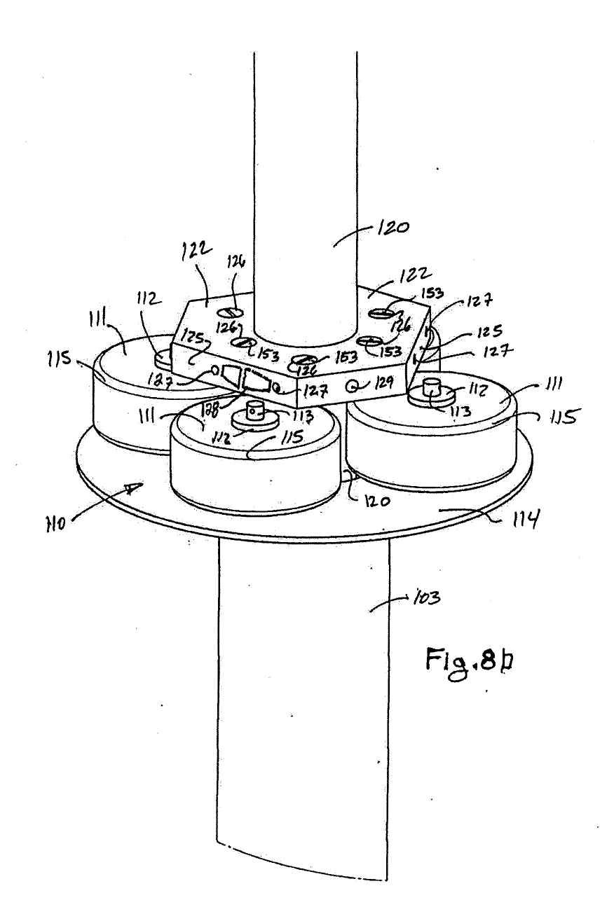

FIGS. 8a and 8b are perspective views showing details of a shaft stabilizing assembly of the wind turbine structure of FIG. 1. In FIG. 8b, supporting arms 140 have been removed to show details of a lower connecting hub of the wind turbine. Referring at once to FIGS. 8a and 8b, a shaft stabilizing assembly 110 is devised to provide radial rotary support about the shaft 120 of the wind turbine 100. The stabilizing assembly 110 comprises a plurality of coplanar wheels, for example three (3) wheels 111, each having a low friction central part 112, rotatably mounted on shafts 113 projecting upwardly from a ring 114, which is itself mounted on the top section 103 of the tower 101 or to a like support structure. The central parts 112 may comprise permanently lubricated bushings or ball bearing couplings. Each wheel 111 may further be provided on its periphery with an outer layer of compliant material 115 such as rubber or an elastomeric material, for example polyurethane or neoprene. The wheels 111 may be equally distributed about a circular path concentric with the shaft 120 and so assembled to contact the shaft to provide radial rotary support thereof. Thanks to the outer layer of compliant material 115, a soft, resilient coupling contact with the shaft 120 is enabled, thereby preventing any gap therebetween and providing shaft vibration damping. For maintenance of the stabilizing assembly 110, the wheels 111 may be replaced without removing the shaft 120.

The lower end of the shaft 120 may be directly connected to and supported by an upwardly projecting shaft of an electrical power generator (not shown) mounted into the generator compartment 104. In an embodiment, a profile of the supporting arms 140, with proper angular tilting of the supporting arms 140 with respect to wind direction, may create a vertical lift transferred to the shaft 120, in turn lowering the axial load and friction imposed by the wind turbine 100 on a generator shaft bearing device in compartment 104, improving efficiency and reducing wear.

According to another aspect of the present disclosure, in an embodiment, the wind turbine 100 may be provided with an additional feature to further improve a safety aspect. Indeed, returning to FIG. 5b, given the hollow structure of the blades 130 and of the supporting arms 140, which are provided with longitudinal channeling cavities such as 141, safety cables 170 may be routed through the inside of the structure, in some of such cavities 141, to provide a safety linkage between the parts, so to hold to the shaft 120 any portion of a part becoming loose following breakage. For example, as shown on FIG. 2, the cables 170 may have first ends (not explicitly shown) connected to the hub 121, the cables 170 extending through the supporting arms 140 and through corresponding blades 130, and have second ends (not explicitly shown) connected to the hub 122. Alternatively, the cables 170 may further extend through the shaft 120 to form loops. The cables 170 may optionally run from one end of each blade 130 to the other end of the blade 130, effectively attaching the blade 130 and their corresponding supporting arms 140, retaining all parts attached in case of failure at the connection with the supporting arms 140. On FIG. 2, only one cable 170 providing safety to one blade 130 and to one pair of supporting arms 140 is shown. Of course, cables 170 may be present in the other blades 130 and supporting arms 140 as well.

As mentioned hereinabove, it is contemplated that tensioning rods 150 may be substituted by other tensioning members such as wires by providing appropriate fastening means to connect to the hubs 121, 122 and end caps 160. Such wires may at once provide the tension function and, in addition provide, a safety securing function by connecting together parts of the blades 130 and of the supporting arms 140 that may be subject to failure.

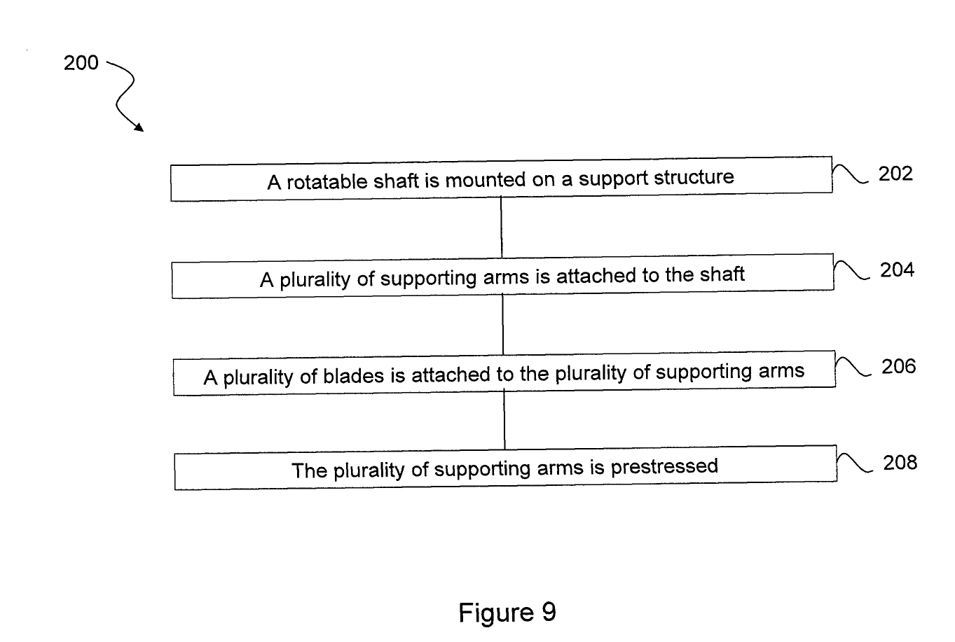

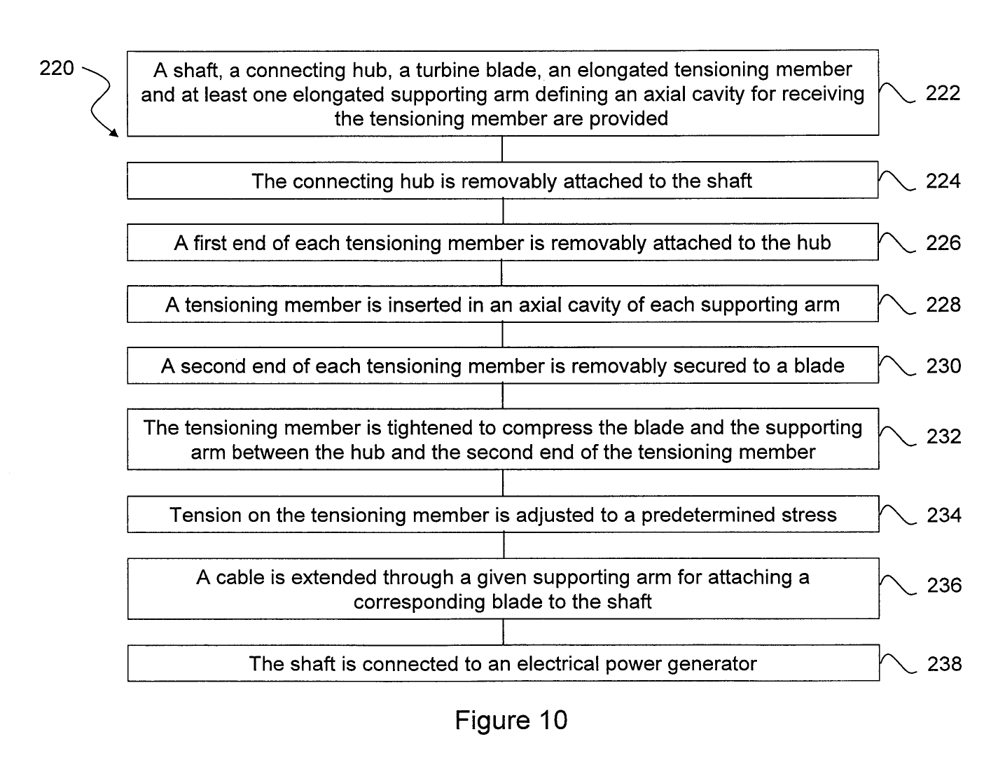

The present disclosure further provides a method for assembling a wind turbine. FIG. 9 shows steps of a first exemplary method for assembling a wind turbine. In an embodiment, a sequence 200 comprises a step 202 of mounting a rotatable shaft on a support structure, which may for example be a tower, a pole, a mast or like structure. At step 204, a plurality of supporting arms is attached to the shaft. At step 206, a plurality of blades is attached to the shaft using the plurality of supporting arms, for example using two (2) parallel supporting arms disposed both near a top and a bottom of the shaft. Then at step 208, the plurality of supporting arms is prestressed. Prestress of the supporting arms will, in operation, oppose at least in part centrifugal forces within the wind turbine. FIG. 10 shows steps of a second exemplary method for assembly a wind turbine. A sequence 220 first comprises a step 222 of providing a shaft, a connecting hub, a turbine blade, an elongated tensioning member and at least one elongated supporting arm defining an axial cavity for receiving the tensioning member. A next step 224 comprises attaching the connecting hub to the shaft. In an embodiment, attaching the connecting hub to the shaft and attaching other elements of the wind turbine is made using removable fasteners. Of course, permanent means for attaching or securing the various components of the wind turbine may also be contemplated. Another step 226 comprises removably securing a first end of the tensioning member to the hub, as illustrated in FIG. 4. In a next step 228, the tensioning member is inserted throughout said supporting arm through said cavity, as shown in FIGS. 5a and 5b. Then at step 230, the blade is removably secured to a second end of the tensioning member, as illustrated in FIGS. 6, 7a and 7b, which step effectively attaches the blade to the supporting arm. The tensioning member is tightened in position at step 232, whereby the blade and the supporting arm are compressed between the hub and the second end of the tensioning member. The method may further comprise a step 234 of adjusting a tension in said tensioning member for compressing the blade and the supporting arm with a predetermined stress. The predetermined stress may for example be calculated according to a centrifugal force on the wind turbine at an expected maximum rotation speed or at an expected maximum wind force. A safety cable may be extended through a supporting arm, at step 236, for attaching a blade to the shaft, as illustrated in FIG. 2. Owing to the cable, the blade and the supporting arm are prevented from becoming loose following breakage. The wind turbine may then be connected, at step 238, to an electrical power generator, or to any other device using rotary power.

Although the present disclosure has been described hereinabove by way of non-restrictive, illustrative embodiments thereof, these embodiments can be modified at will within the scope of the appended claims without departing from the spirit and nature of the present disclosure.

What is claimed is:

1. A vertical axis wind turbine comprising:
an upright rotatable shaft mountable on a support structure;
a plurality of upright blades; and
a plurality of prestressable supporting arms for attaching the plurality of blades to the shaft.

2. The turbine of claim 1, wherein each supporting arm comprises a tensioning member for connecting a corresponding blade to the shaft while submitting the supporting arm to a compression stress.

3. The turbine of claim 2, comprising, in each supporting arm, an axial cavity for receiving the tensioning member.

4. The turbine of claim 2, comprising, in each supporting arm, a rod for exerting the compression stress on the supporting arm.

5. The turbine of claim 2, comprising, in each supporting arm, a tensioning wire for exerting the compression stress on the supporting arm.

6. The turbine of claim 1, wherein an amount of prestress of each supporting arm is determined according to a centrifugal force on the wind turbine at an expected maximum rotation speed.

7. The turbine of claim 1, wherein an amount of prestress of each supporting arm is determined according to a centrifugal force on the wind turbine at an expected maximum wind force.

8. The turbine of claim 1, comprising a hub for attaching the supporting arms to the shaft.

9. The turbine of claim 1, comprising a pair of prestressable supporting arms for holding each blade.

10. The turbine of claim 9, comprising an upper hub for attaching upper prestressable supporting arms to the shaft and a lower hub for attaching lower prestressable supporting arms to the shaft.

11. The turbine of claim 1, wherein the blades have an aerofoil cross-section.

12. The turbine of claim 1, wherein the blades are straight along a vertical length.

13. The turbine of claim 1, comprising:
a shaft stabilizing assembly comprising a plurality of wheels rotatably mounted on the support structure for radially and rotatably supporting the shaft.

14. The turbine of claim 13, wherein each wheel comprises a compliant outer layer for resilient contact with the shaft.

15. The turbine of claim 1, comprising:
a cable extending through at least one of the plurality of supporting arms for attaching at least one of the plurality of blades to the shaft;
whereby the at least one of the plurality of blades and the at least one of the plurality of supporting arms are prevented from becoming loose following breakage.

16. The turbine of claim 1, wherein the supporting arms have an aerofoil cross-section.

17. The turbine of claim 1, wherein the supporting arms are angularly tilted for applying a vertical lift on the shaft.

18. A method for assembling a wind turbine, the method comprising:
mounting a rotatable shaft on a support structure;
attaching a plurality of supporting arms to the shaft;
attaching a plurality of blades to the plurality of supporting arms; and
prestressing the plurality of supporting arms.

19. The method of claim 18, comprising:
connecting the shaft to an electrical power generator.

20. The method of claim 18, comprising:
attaching a connecting hub to the shaft;
inserting a tensioning member in an axial cavity of each supporting arm;
securing a first end of each tensioning member to the hub; and
securing a second end of each tensioning member to a blade.

21. The method of claim 20, comprising:
tightening the tensioning member to compress the blade and the supporting arm between the hub and the second end of the tensioning member.

22. The method of claim 18, comprising:
extending a cable through a given supporting arm for attaching a corresponding blade to the shaft;
whereby the given supporting arm and the corresponding blade are prevented from becoming loose following breakage.

23. A shaft stabilizing assembly, comprising:
a plurality of coplanar wheels having compliant outer layers, rotatably mounted on a support, for radially and rotatably supporting a rotatable shaft.

24. Use of the shaft stabilizing assembly of claim 23 for stabilizing a wind turbine.

25. A vertical axis wind turbine comprising:
an upright rotatable shaft mountable on a support structure;
a plurality of upright blades; and
a plurality of prestressed supporting arms for attaching the plurality of blades to the shaft.
